(19) United States
(12) Patent Application Publication
(10) Pub. No.: US 2005/0099766 A1
(43) Pub. Date: May 12, 2005

(54) Transportable mass data storage system

(76) Inventors: Peter Donald Fraley, Minneapolis, MN (US); Ronald Allen Major, Prior Lake, MN (US); Tim John Larson, Elk River, MN (US); Adam Charles Blomberg, Wake Forest, NC (US); Slava Gekht, Rosemount, MN (US); Dale Thomas Hoepner, Buffalo, MN (US); Rodney Elmer Berg, Plymouth, MN (US); Richard Norman Vignes, St. Louis Park, MN (US); Jeffrey Scott Haider, Golden Valley, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/807,513

(22) Filed: Mar. 22, 2004

Related U.S. Application Data
(60) Provisional application No. 60/456,362, filed on Mar. 20, 2003.

(51) Int. Cl. G06F 1/16

(52) U.S. Cl. 361/685; 312/223.1; 312/223.2; 361/695

(57) ABSTRACT

The invention provides apparatus and methods for a removable and transportable mass data storage system assimilating multiple levels of abstraction, automation and hot-swappable, fault-tolerant modularization. In providing such a system, a means for or method of reducing or bypassing the amount of time needed for information exchange before such system can be removed and transported is provided. The means or method enables the information to be quickly physically transported from a hardware platform in which it was acquired to a hardware venue in which it could be examined, offloaded, stored, safeguarded, or the like. The means or method would enable rapid insertion of blank media for an immediate continuance of any originating process. The means or method would facilitate rapid exchanges of databases, expert systems, multimedia content, reconnoitered information, and the like.

### RELATED APPLICATIONS

The present Application claims the benefit of U.S. Provisional Patent Application Ser. No. 60/456,362, filed Mar. 20, 2003. The entire disclosure of the above-mentioned patent application is hereby incorporated by reference herein.

### FIELD OF THE INVENTION

The invention relates to computer mass data storage peripherals.

### BACKGROUND OF THE INVENTION

In military, security, multimedia, telemetry, medical, reconnaissance, and other applications, there is often a need to exchange massive quantities of storage media information as rapidly as possible. Unfortunately, the actual exchanging of such information can be a lengthy event due in large part to the limited upload/download bandwidths of the host computer interface that facilitates the exchange. In providing a means for or method of reducing or bypassing the amount of time spent waiting for such information exchange, one accomplishes many objectives. First, the means or method would enable the information to be quickly physically transported from a hardware platform or “venue” (i.e., at a fixed locale or moving vehicle) in which it was acquired to a hardware venue in which it could be examined, offloaded, stored, safeguarded, etc. Second, the means or method would enable rapid insertion of blank media for an immediate continuance of any originating process, e.g., data recording. Third, the means or method would facilitate rapid exchanges of databases, expert systems, multimedia content, reconnoitered information, etc.

In certain applications of those noted above, a subsequent step to exchanging the massive quantity of storage media information is often actually physically transporting the information to another locale or hardware platform. Thus, in these applications where physical transport is desired, there exists a need for a means or method for safely harboring the information during the physical transport.

All of these needs are addressed with this invention.

### SUMMARY OF THE INVENTION

In accordance with certain embodiments, there is provided an apparatus comprised of a removable and transportable mass data storage system assimilating multiple levels of abstraction, automation together with hot-swappable, fault-tolerant modularization. A single, compact, self-contained, removable storage module that is comprised of a plurality of storage units whose aggregate data capacity ranges up to, or more than, an order of magnitude above that of the individual storage unit is generally involved. The module is easily interfaced to facilitate its removal and transport, which, in turn, enables such applications as offline archived storage, informational or database exchanges, disaster safeguarding, content secrecy protection, rapid destruction of confidential information, and the like.

The embodiments provide computer storage peripherals which enable the removable storage module to be interfaced to the host system via integrated controllers that are continuously available to the host system regardless of the deployment status of the removable storage module, i.e., whether or not the module is installed or has been removed. In addition, the integrated controllers present the removable storage module in an abstracted form as a single media device rather than the plurality of storage units of which it consists. Further, the controllers autonomously create a redundant data system on the storage units capable of surviving single points of failure, and use autonomous data stream manipulations to increase media access bandwidth across the host system interface.

Certain embodiments provide a storage peripheral that is ruggedized (i.e., capable of withstanding shock, vibration and environmental extremes). Further, there are provided storage peripherals that incorporate multiple levels of redundancy for high data availability and further ruggedization. These aspects of redundancy exist at the gross hardware level using rapidly exchangeable self-contained canister modules, at an abstracted hardware level (e.g., the aforementioned redundant data system), and at the embedded software level that abstracts and automates, in its presentation to the host system, the redundant and/or removable components and data.

The embodiments provide apparatus that is preferably configured for fault-tolerance, both at the component and embedded firmware levels, to ensure a cost-efficient and operationally effective system with ease of integration via high levels of abstraction and standardized communication protocols. For example, the end-users would have little use in providing systems with spare online hard-drives for fault-tolerance if they had no way of dealing with the enormous tasks of creating and maintaining a redundant data configuration on those drives and developing the many complex operations needed to recover or restore lost data from failed drives and rebuild fault-tolerance on replacement drives, as well as developing the hardware acceleration necessary to do all this with a minimal impact on real-time transmission bandwidth. However, even if such systems could be implemented in theory, the real world application would be subject to mechanical, electronic and power design limitations.

The embodiments provide apparatus having the capability for user and host software application communication with the mass storage system for continuous automated or remote manual control of all external physical interactions with the mass data storage system as well as pertinent internally-detected or internally-directed conditions, states and sequences. Multiple standardized software, firmware and hardware protocols would be preferably provided for these communication paths (e.g., in-band and out-of-band storage management utilities, SMTP event notifications, SNMP monitoring and administration, standardized in-band commands and feedback, LAN and WAN backbone layers, visual/audio indicators, IrDA interface, wireless communications, etc.).

In certain embodiments, there is provided a computer drive pack assembly comprising a principal enclosure, a housing within the principal enclosure, and at least one RAID controller within the principal enclosure. The housing is adapted for removal and transport from the principal enclosure. The housing contains a plurality of drives, where each of the plurality of drives is adapted for removal from the housing. The at least one RAID controller is operatively connected to one or more of the plurality of drives. The at least one RAID controller is configured to store data for the connected drives.

In other certain embodiments, there is provided a computer drive pack assembly comprising a principal enclosure, a drive pack, one or more support modules, and an enclosure circuit. The drive pack is operatively coupled to the principal enclosure and adapted for removal and transport from the principal enclosure. The drive pack contains a plurality of drives, where each of the plurality of drives is adapted for removal from the housing. The one or more support modules are operatively coupled to the principal enclosure. The enclosure circuit is operatively coupled to the principal enclosure and configured to interconnect the drive pack and the one or more support modules.

In additional certain embodiments, there is provided a method of creating a redundant data system in a computer pack assembly. The method comprises providing a principal enclosure having one or more support modules and an enclosure circuit contained therein. The method includes providing a drive pack adapted for removal and transport from the principal enclosure, where the drive pack is comprised of a housing containing a plurality of drives and a drive circuit, where each of the plurality of drives is adapted for removal from the housing. The method involves coupling operatively the drive pack to the principal enclosure.

In further certain embodiments, there is provided a method of enabling a plurality of drives to function properly within a computer drive pack assembly following insertion of a drive pack containing the plurality of drives into the computer drive pack assembly. The method comprises powering the drive pack; initializing a drive circuit of the drive pack to default control status with an electronic circuit within the computer drive pack assembly; testing the drive pack; enabling the plurality of drives on back-end storage media interfaces of the computer drive pack assembly; powering the plurality of drives within the drive pack; testing the plurality of drives for readiness; reading data from the plurality of drives; synchronizing the computer drive pack assembly with data from the plurality of drives; and setting one or optionally more of visual, audio, and in/out of band notifications that proper functioning between the plurality of drives of the drive pack and the computer drive pack assembly is now available.

In other certain embodiments, there is provided a method of enabling a plurality of drives to function properly within a second computer drive pack assembly following removal of a drive pack containing the plurality of drives from a first computer drive pack assembly. The method comprises disabling further data transfers between the drives and the first computer drive pack assembly; flushing write-cache to the plurality of drives; bypassing individual drives from internal data buses; powering down a plurality of drives within the drive pack; setting controls and statuses for drive pack disengagement; setting one or optionally more of visual, audio, and in/out of band notifications that user can now safely remove the drive-pack; and setting one or optionally more of visual, audio, and in/out of band notifications of any errors in the drive-pack ejection sequence.

In additional certain embodiments, there is provided a computer readable medium comprising the instructions for performing the method of enabling a plurality of drives to function properly within a computer drive pack assembly following insertion of a drive pack containing the plurality of drives into the computer drive pack assembly.

In further certain embodiments, there is provided a computer readable medium comprising the instructions for performing the a method of enabling a plurality of drives to function properly within a second computer drive pack assembly following removal of a drive pack containing the plurality of drives from a first computer drive pack assembly.

### BRIEF DESCRIPTION OF THE DRAWINGS

FIG. 1 is a schematic, front perspective view of a computer drive pack assembly in accordance with certain embodiments of the invention;

FIG. 2 is a schematic, front perspective view of the computer drive pack assembly of FIG. 1;

FIG. 3 is a schematic, front exploded perspective view of a drive pack in accordance with certain embodiments of the invention;

FIG. 4 is a schematic, rear perspective view of both a principal enclosure and a fully-assembled drive pack in accordance with certain embodiments of the invention;

FIG. 5 is a schematic, front perspective view of both the principal enclosure and the drive pack of FIG. 4;

FIG. 6 is a schematic, front perspective view of a Drive Service Board in accordance with certain embodiments of the invention;

FIG. 7 is a schematic, front perspective view of an Enclosure Services Interface (ESI) Board in accordance with certain embodiments of the invention;

FIG. 8 is a schematic, rear exploded perspective view of the computer drive pack assembly of FIG. 1;

FIG. 9 is a schematic, rear perspective view of the computer drive pack assembly of FIG. 1;

FIG. 10 is a schematic, front perspective view of a User Interface Module in accordance with certain embodiments of the invention;

FIG. 11 is a schematic, front perspective view of both the computer drive pack assembly of FIG. 1 and an individual drive in accordance with certain embodiments of the invention;

FIG. 12 is a block diagram illustrating a system process for installing a drive pack in accordance with certain embodiments of the invention;

FIG. 13 is a block diagram illustrating a system process for removing a drive pack in accordance with certain embodiments of the invention; and

FIG. 14 is a schematic front perspective view of a drive shuttle in accordance with certain embodiments of the invention.

### DETAILED DESCRIPTION OF PREFERRED EMBODIMENTS

The following detailed description is to be read with reference to the drawings, in which like elements in different figures have like reference numerals. The drawings, which are not necessarily to scale, depict selected embodiments, but are not intended to limit the scope of the invention. It will be understood that many of the specific details incorporating the system illustrated in the drawings could be changed or modified by one of ordinary skill in the art without departing significantly from the spirit of the invention.

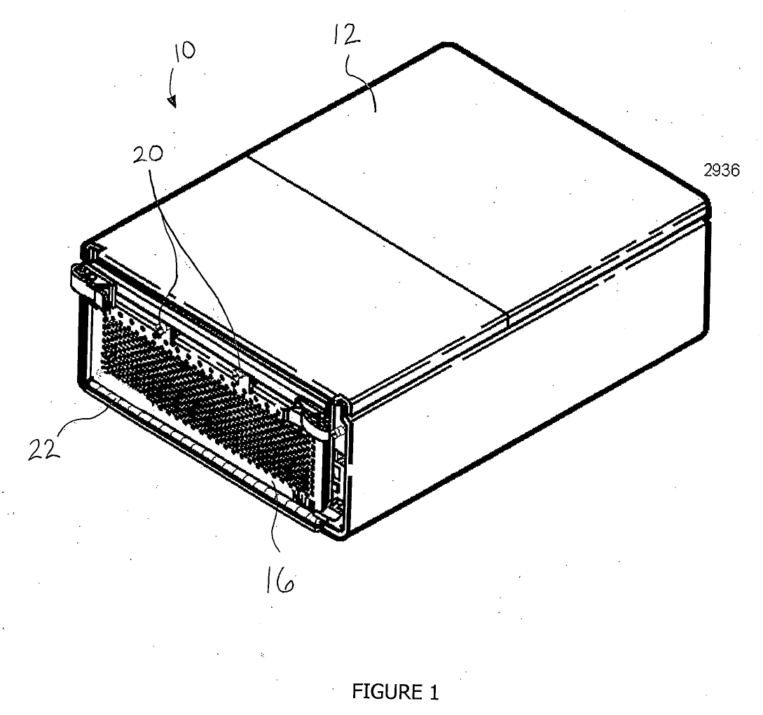

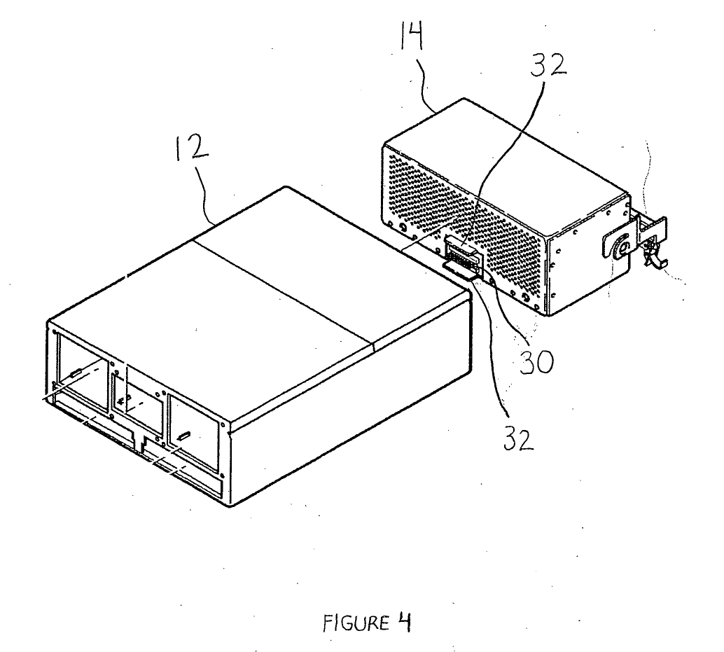

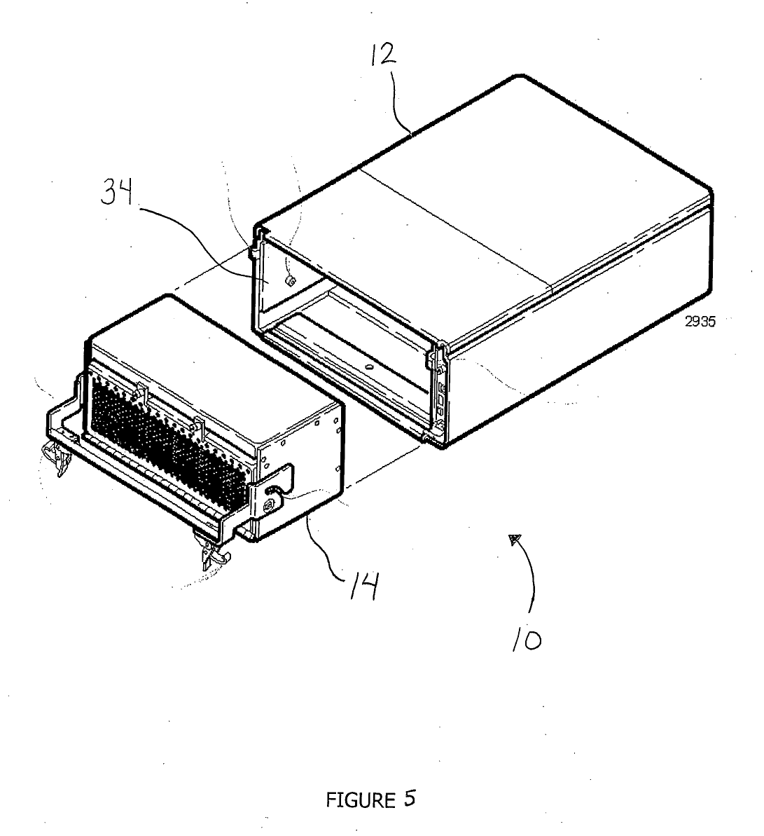

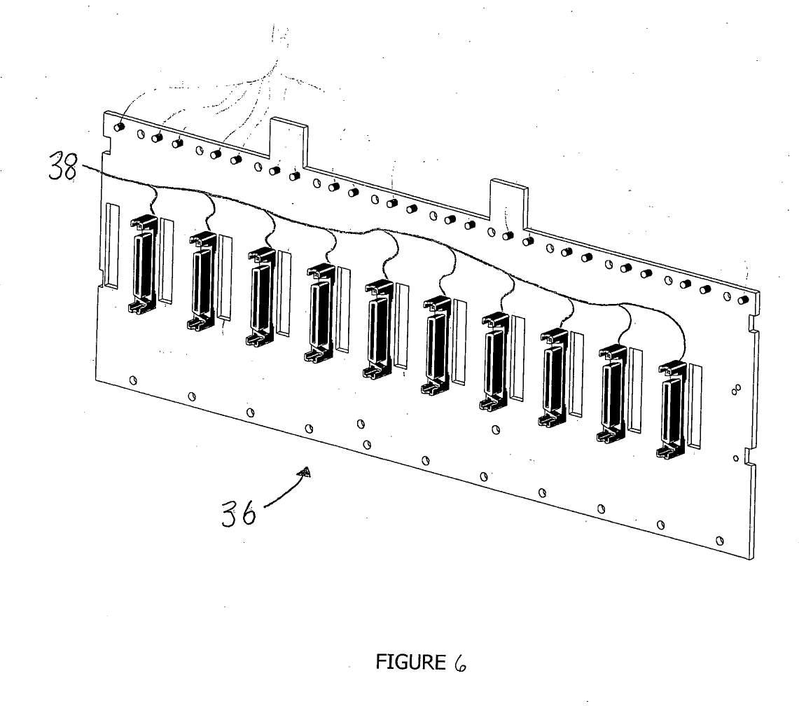

FIG. 1 illustrates a front perspective view of a computer drive pack assembly 10 in accordance with certain embodiments of the invention. The term “computer drive pack assembly” could be replaced by a number of relatively similar terms (e.g., computer peripheral apparatus, modular data device assembly, fault tolerant computing facility, etc.) that those skilled in the art would also recognize, however “computer drive pack assembly” will be used herein for conventional purposes and not with the intention of limiting the invention as such. As shown, the computer drive pack assembly 10 has all removable modular components installed in a principal enclosure 12. The principal enclosure 12 is comprised of sheet metal or the like for providing structural support and rigidity as well as EMI (Electromagnetic Interference) shielding. A removable drive pack 14 (illustrated separately from the principal enclosure 12 in FIGS. 4 and 5 and not visible in FIG. 1) is in a fully inserted and locked-down state in the enclosure 12. The term “drive pack” could be replaced by a number of relatively similar terms (e.g., mass media storage system, disk carrier body, hard disk drive module, etc.) that those skilled in the art would also recognize, however “drive pack” will be used herein for conventional purposes and not with the intention of limiting the invention as such. The front of the drive pack 14 (not shown) is covered with a drive protection panel 16 that is shown in its closed position.

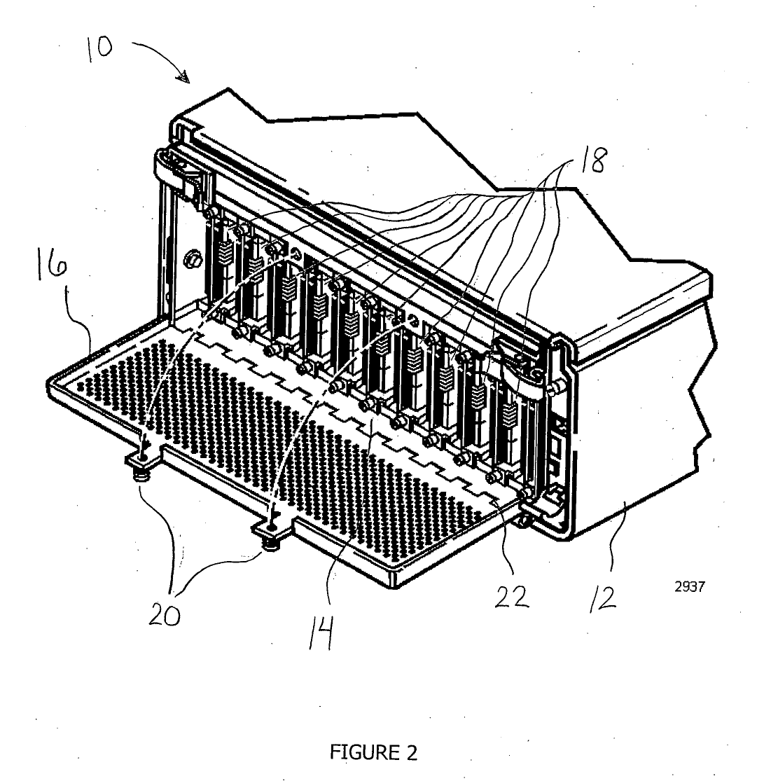

FIG. 2 shows a front perspective view of the drive pack 14 in its open position. A plurality of individual drives 18 are contained within the drive pack 14, as illustrated. The term “drive” could be replaced by a number of relatively similar terms (e.g., random access memory device, hard disk module, mass storage device, etc.) that those skilled in the art would also recognize, however “drive” will be used herein for conventional purposes and not with the intention of limiting the invention as such. In certain preferred embodiments of the invention, referencing FIGS. 1 and 2, the drive protection panel 16 is secured at the top edge of the drive pack 14 with fasteners 20 and at the bottom edge of the drive pack 14 with a hinge 22. The drive protection panel 16 is provided as a door in order to physically protect the individual drives 18 inside the drive pack 14 while also allowing access to the drives 18 during active data transfers to and from corresponding media (not shown). Further, the drive protection panel 16 provides for EMI (electromagnetic interference) shielding, includes perforations to allow proper airflow intake, may include brackets to hold an air filter (not shown), and provides for protection from improper user interaction involving either accidental modifications (via a tool-less fastener design) or deliberate tampering (via a key lock design).

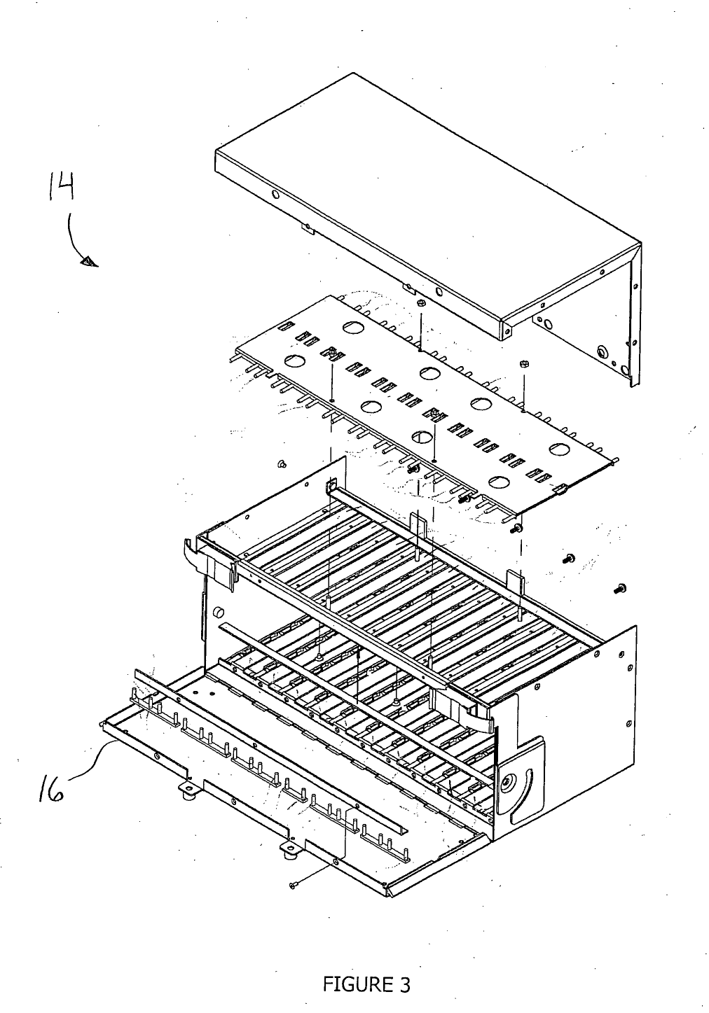

The drive pack 14 is generally a housing adapted for removal and transport from the principal enclosure 12. The drive pack 14 may be of a ruggedized construction as shown in FIG. 3; however, the construction and overall design of the drive pack 14 is not limited as such. Referencing FIG. 4, an ultra-high insertion rated electronic signal and power connector 30 rated for high current transfer is preferably located in the rear of the drive pack 14, and forms the sole electronic signal and power interconnection (i.e., blind-mate connection) between the principal enclosure 12 and the drive pack 14. A portion of the connector 30 that protrudes from the drive pack 14 is preferably flanked with heavy gauge tab extensions 32 above and below the connector 30 to act as a protection mechanism for the connector 30 during transport of the drive pack 14.

FIG. 5 illustrates a front perspective view of both the drive pack 14 and the principal enclosure 12 of the computer drive pack assembly 10. As such, the drive pack 14 and the principal enclosure 12 are depicted as separate units. The drive pack bay 34 is an opening at the front of the principal enclosure 12, from which the drive pack 14 may be removed (or alternately inserted if the bay 34 is empty). In certain embodiments of the invention, the drive pack 14 and principal enclosure 12 function together to provide a secure engagement of the drive pack 14 to the principal enclosure 12. In certain preferred embodiments of the invention, during drive pack 14 insertion, the drive pack 14 and the principal enclosure 12 function together to secure the electrical connection of the electronic signal and power connector 30 (depicted in FIG. 4, not visible in FIG. 5) to a corresponding connector as well as secure the drive pack 14 to the principal enclosure 12.

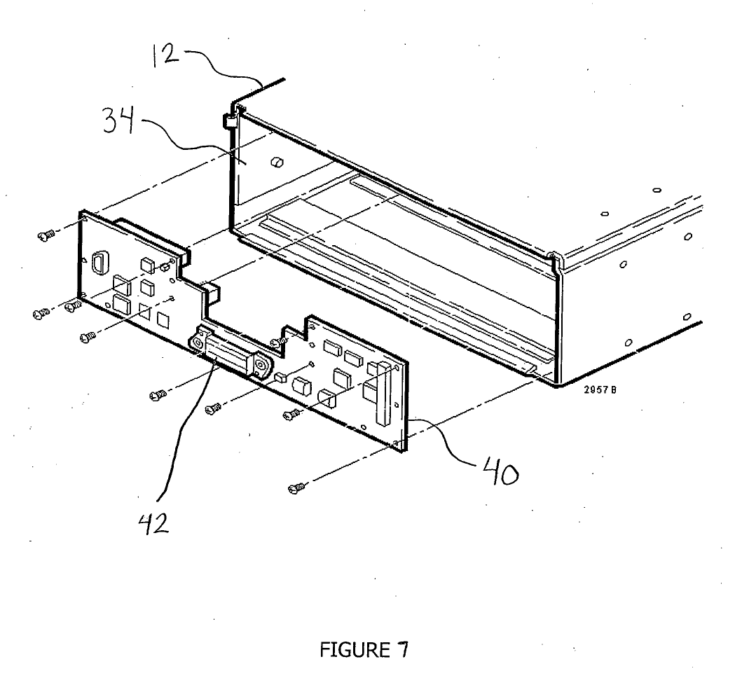

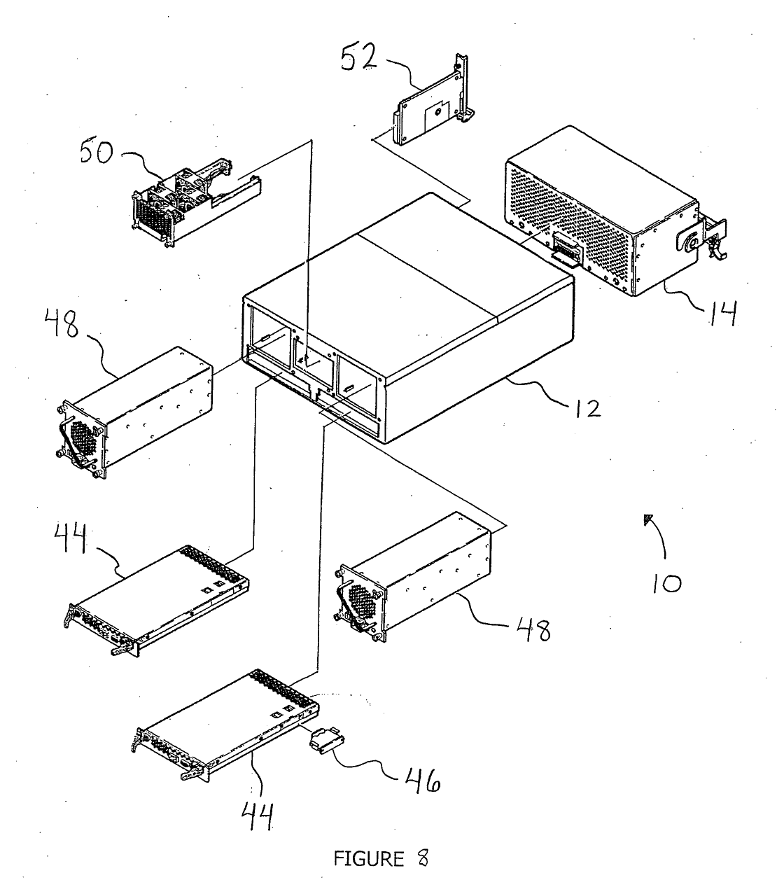

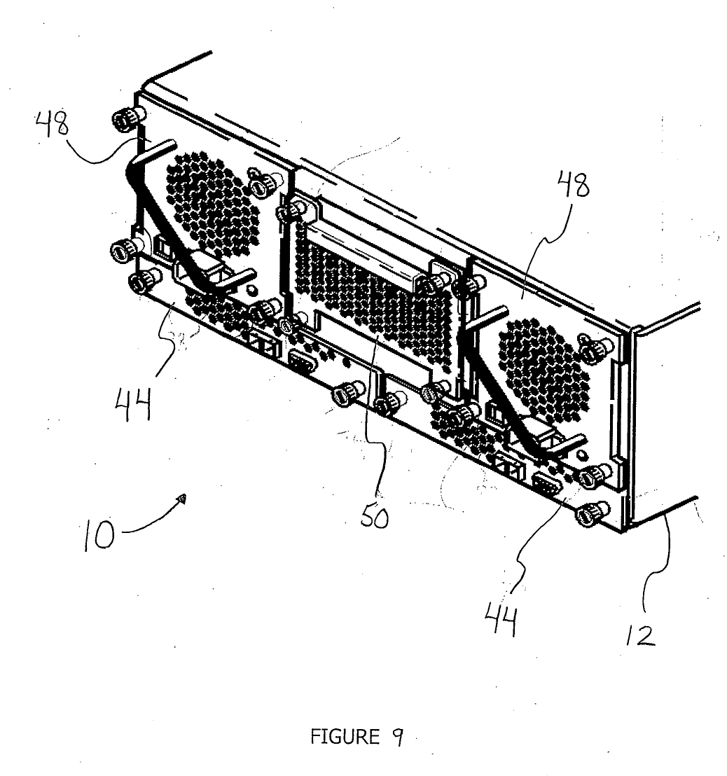

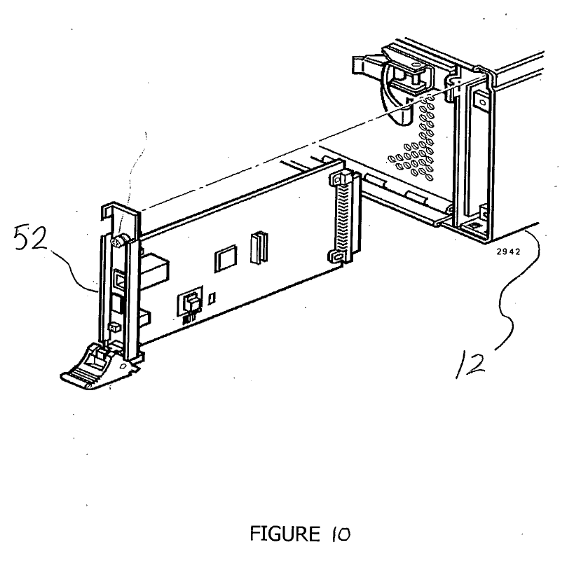

FIG. 6 shows a front perspective view of the Drive Service Board 36, which is generally mounted at the rear of the drive pack 14. In addition to supporting LEDs for lighted drive indicators, the Drive Service Board 36 comprises a circuit such as a printed circuit board (not shown) that includes the individual drive connections 38, control logic, monitoring logic, sensors, data bus channels, power distribution and control, status logic, LED control, and all other interconnections as described below for the entire drive pack 14. In turn, the Drive Service Board 36 has individual power and data bus bypass control to each of the drives 18, yet is managed by several processors and at least one control board in the principal enclosure 12 (FIG. 7), and makes its electronic signal and power connection to the principal enclosure 12 via the connector 30 of FIG. 4. As generally depicted in FIG. 7, at the rear of the drive pack bay 34 of the principal enclosure 12, anterior to a furthest extent of the inserted drive pack 14, is an ESI (Enclosure Services Interface) printed circuit board 40, preferably oriented parallel to a rear surface of the inserted drive pack 14. FIG. 7 illustrates a front perspective view of the ESI Board 40 to preferably have a screw-mount configuration to internally couple to a framework of the principal enclosure 12. However, in other embodiments, the ESI Board 40 may comprise a side-mounted field-replaceable unit requiring minimal tool-work for extraction and exchange (e.g., held in place by clips, thumbscrews, etc.). The ESI Board 40 includes a female connector 42 which couples with the electronic signal and power connector 30 of the drive pack 14. In turn, the ESI Board 40 functions as an interconnect between the drive pack 14 and all the peripheral support modules of the computer drive pack assembly 10. These peripheral support modules (shown in FIG. 8) will be detailed later, however the modules include at least one RAID (Redundant Array of Independent Drives) controller 44, at least one RAID controller rechargeable battery backup unit 46, at least one redundant power supply 48, at least one fan pack 50, and at least one User Interface Module 52.

The ESI Board 40 provides DC power distribution and filtering, inter-module signal connectivity, enclosure services status and control processing, drive pack services (i.e., power, power control, redundant data bus distribution and bypass control logic, status and management processing, and environmental monitoring), and processing for a plurality of user interfaces. The ESI Board 40 has automated control of the Drive Service Board 36 via at least one embedded processor located on the ESI Board 40. Further, the ESI Board's control logic, status logic, and embedded microprocessors, working in concert with the electronics on the Drive Service Board 36, automate the power, initialization, testing, and various electronic sequences involved in the drive pack 14 insertion and ejection from the principal enclosure 12 of the computer drive pack assembly 10.

In particularly preferred embodiments of the invention, the computer drive pack assembly 10 will have numerous design considerations for fault tolerance. These considerations largely involve incorporating modularized, redundant components designed for rapid, online exchange in the event of malfunctions. These components generally include the ESI Board 40 as well as the peripheral support modules (shown in FIG. 8) of the computer drive pack assembly 10, namely the at least one RAID (Redundant Array of Independent Drives) controller 44, the at least one RAID controller rechargeable battery backup unit 46, the at least one redundant power supply 48, and the at least one fan pack 50. With regard to the “online exchange”, single point failures can be tolerated and repaired with little or no impact to ongoing primary operations as a mass storage peripheral.

As previously described, one of the fault tolerant aspects of the invention preferably comprises the at least one redundant power supply 48 with integrated fans. FIGS. 8 and 9 show perspective views of the computer drive pack assembly 10 in accordance with certain embodiments of the invention. In both FIGS. 8 and 9, two power supplies 48 are depicted. In particular, FIG. 8 displays the power supplies 48 and the principal enclosure 12 as separate units, with the power supplies 48 being in self-contained canisters. In certain embodiments of the invention, at least one power supply 48 converts AC input voltages to DC output voltages distributed throughout the computer drive pack assembly 10. This distribution is facilitated by blind-mate connections (i.e., for DC power, control, and status) made between the ESI Board 40 and the at least one power supply 48.

Another of the fault tolerant aspects of the invention preferably comprises the at least one RAID controller 44. FIGS. 8 and 9 show an exemplary embodiment of the computer drive pack assembly 10 of the invention that includes two RAID controllers 44. In particular, FIG. 8 displays the RAID controllers 44 and the principal enclosure 12 as separate units, with the RAID controllers 44 being in self-contained canisters. In certain embodiments of the invention, there is a blind-mate connection made between the ESI Board 40 and the at least one RAID controller 44, and the ESI Board 40 further acts as interconnect between the at least one RAID controller 44 and the Drive Service Board 36. In certain preferred embodiments of the invention, the at least one RAID controller 44 maintains a continuous communication link with a primary in-band host system interface (e.g., via at least one optical or electrical transceiver) regardless of deployment status of the drive pack 14. The communication link serves to abstract the drive pack deployment via industry standard protocols (e.g., SCSI over Fibre Channel, SCSI over IP, 1394, etc.), thus causing insertions and removals of the drive pack 14 to appear to the host operating system as simple, standardized removable media exchanges (akin to e.g., floppy disk, CD/DVD media or plug-n-play USB peripherals). The interface is either an active-active configuration, i.e., for aggregate host bandwidth, or an active-passive configuration, i.e., for fault-tolerant redundancy, with auto cache mirroring across the back-end drive buses. Another fault tolerant aspect of the invention that would preferably work in conjunction with the at least one RAID controller 44 includes at least one rechargeable battery backup unit (BBU) 46 to protect cached data on the at least one controller 44 in the event of a power failure. In certain preferred embodiments of the invention, the at least one BBU 46 would be side-accessible on the at least one controller 44 for ease of replacement.

The at least one RAID controller 44, using embedded software algorithms and embedded hardware acceleration, builds and maintains automated control of the drive data streams and data pathways to create parity-based data redundancy on the set of drives 18 in the drive pack 14 real-time during host transfers for fault tolerance. In case of a drive failure, the at least one RAID controller 44 handles drive shutdown and replacement procedures, performs on the fly parity-based algorithmic reconstruction of missing redundant data on either the replacement drive or the hot-spare drive, and tests data redundancy on replacement drives after their physical installation or logical integration from a hot-swap standby mode. All processes, statuses and controls of these drive fault tolerance procedures are fully communicated to/from the user via standard protocols over the in-band and out-of-band communication paths, as is known in the art of storage area network (SAN) applications. The at least one RAID controller 70 automates and abstracts these procedures to the host interfaces, thus allowing the user to engage in as much, or as little, control and monitoring as they wish. As such, user integration and usage of the invention is vastly simplified.

The at least one RAID controller 44 further encapsulates other removable media mass storage aspects to simplify user integration and usage of this invention. Aspects include the automation of the installation and ejection of the removable drive pack 14, the abstraction of removable media processes to the host, and the automation and abstraction of drive fault tolerance data generation and fault recovery. In addition, the at least one RAID controller 44 abstracts the plurality of individual drives 18 contained in drive pack 14 and presents them to the host system as a single, consolidated, massive virtual drive, thus vastly simplifying host operating system integration of this peripheral. The plurality of drives 18 is further abstracted into a plurality of logical units (LUN's), unrestricted by individual drive physical boundaries. LUN's can be optimized for capacity, bit-zone media bandwidth speeds, cost of redundancy, etc. Furthermore, each LUN is assigned its own RAID binding level. By taking into account each LUN's particular storage usage, RAID binding-type tradeoffs can be used to further optimize performance and the cost of redundancy.

Another of the fault tolerant aspects of the invention preferably comprises the at least one modular fan pack 50 having a plurality of redundant fans, ESI Board-based control, and fault detection circuitry (independent for each fan). FIGS. 8 and 9 show an exemplary embodiment of the computer drive pack assembly 10 of the invention that includes one fan pack 50. In particular, FIG. 8 displays the fan pack 50 and the principal enclosure 12 as separate units, with the fan pack 50 being in a self-contained canister. In certain embodiments of the invention, there is a blind-mate connection made between the ESI Board 40 and the at least one fan pack 50.

The computer drive pack assembly 10 of the invention further includes at least one User Interface Module 52, which is field-replaceable. FIG. 10 shows an exemplary embodiment of the assembly 10 of the invention which includes the User Interface Module 52. In particular, FIG. 10 displays the User Interface Module 52 and the principal enclosure 12 as separate units, with the User Interface Module 52 being integrated to a face-plate. In certain embodiments of the invention, there is a blind-mate connection between the User Interface Module 52 and the ESI Board 40 (not shown). In certain preferred embodiments of the invention, rapid replacement modularity is enabled via the User Interface Module 52 maintaining a plurality of continuous communication links with secondary out-of-band user systems (e.g., Ethernet, wireless LAN or PAN, USB, RS232, IrDA, etc.) through industry standard protocols (e.g., IP over Ethernet, SMTP, SNMP, HTTP, Bluetooth, 802.11b/a, IrTran-P, IrLAN, IrCOMM, etc.). The communication links allow real-time status and control, operational parameter configuration, system testing, remote debugging, event logging, etc., of all aspects of drive pack deployment. In addition, the User Interface Module 52 may preferably indicate status, system and fault information, etc., regarding drive pack 14 deployment via alphanumeric LED/LCD displays and audio indicators. The user can also obtain adjunct information and initiate drive pack operations (e.g., hardware and firmware revisions, drive pack ejection, etc.) via user activated switches.

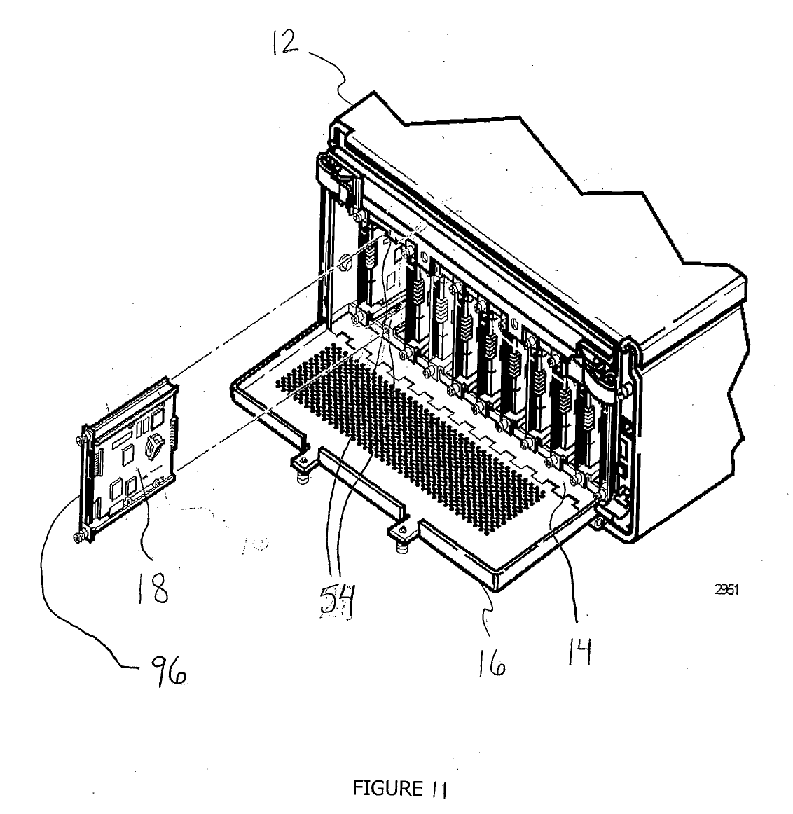

Further preferable fault tolerant aspects of the computer drive pack assembly 10 of the invention preferably comprise at least one hot-spare drive, i.e., an online drive (or drives) designated as a spare, that can be immediately logically exchanged for a malfunctioning drive; and online drive replacement, i.e., a drive can be powered up and brought online while the drive pack 14 is installed and online. FIG. 11 illustrates a certain preferred embodiment of the online drive replacement, showing a cross-sectional front view of the drive pack 14 with the drive protection panel 16 open, and a cross-sectional side view of one of the individual drives 18 outside the drive pack 14. As shown, the drive pack 14 is fully inserted and locked in place in the principal enclosure 12, and the individual drive 18 is positioned to be installed into an unoccupied set of guide rail trays 54 in the drive pack 14. Preferably in both of these fault tolerant aspects, redundant data may be automatically reconstructed and restored on the hot-spare drive via RAID parity calculations made with data from the remaining drives. In certain preferred embodiments of the invention, the reconstruction and restoration would all be done under RAID controller administration autonomously from any host system interaction.

As can be appreciated, all the components (i.e., all the removable modules, the integrated circuit boards, etc.,) housed in the drive pack enclosure 12 generate a considerable quantity of heat. Adequate cooling via forced convection airflow is critical to this invention, especially considering the rugged environments and military applications it may be utilized in. Cooling can be provided any of a variety of methods. One such cooling method could involve directed airflow from perforations in the drive pack 14 or the principal enclosure 12; however, the invention should not be limited as such.

Preferably, the drive pack 14, any of the plurality of drives 18, the ESI Board 40, and the peripheral support modules (i.e., the at least one RAID (Redundant Array of Independent Drives) controller 44, the at least one RAID controller rechargeable battery backup unit 46, the at least one redundant power supply 48, the at least one fan pack 50, and the at least one User Interface Module 52 are all Field Replaceable Units (FRU's). As such, in accordance with a certain embodiment of the invention, all of the FRU's are preferably “hot-swappable” with the computer drive pack assembly 10. In turn, the FRU's can be preferably exchanged while the computer drive pack assembly 10 is under power. In addition, in accordance with a certain embodiment of the invention, all FRU's are “live-comm-access-swappable” with the computer drive pack assembly 10. As such, the FRU's can be exchanged while in-band and out-of-band communication paths are being accessed by the host system and secondary user systems (except for those out-of-band communication paths that are necessarily interrupted during user interface module exchanges, i.e., those packs that travel through user interface modules). Further, in accordance with a certain embodiment of the invention, all FRU's (with the exception of the drive pack 14) are “live-media-access-swappable” with the computer drive pack assembly 10, i.e., the FRU's can be exchanged while storage media data is being accessed by the host system. This includes exchanges involving individual drives 18, provided the RAID binding is maintained across its associated drives 18. RAID bindings are maintained so long as a maximum of one drive exchange per binding occurs between each full reconstruction of redundant data on that binding. Redundant data reconstruction is preferably implemented as an automated process of the RAID controllers 44 as known in the art and requires no host system or user intervention.

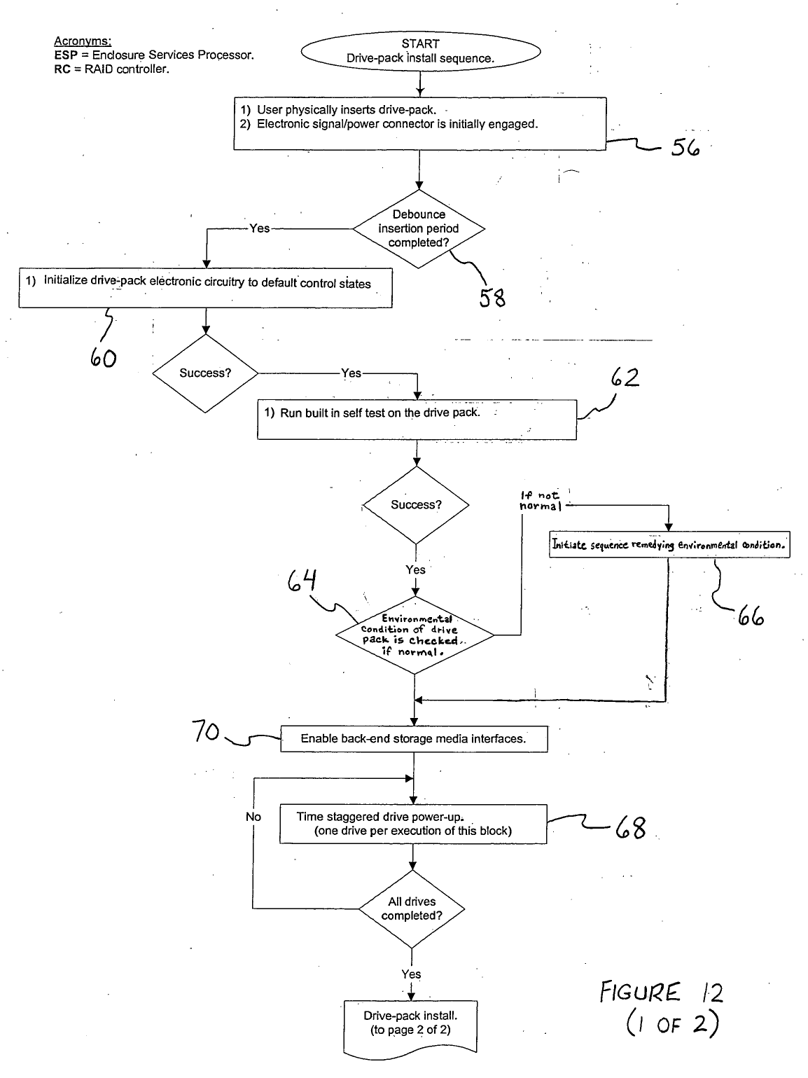

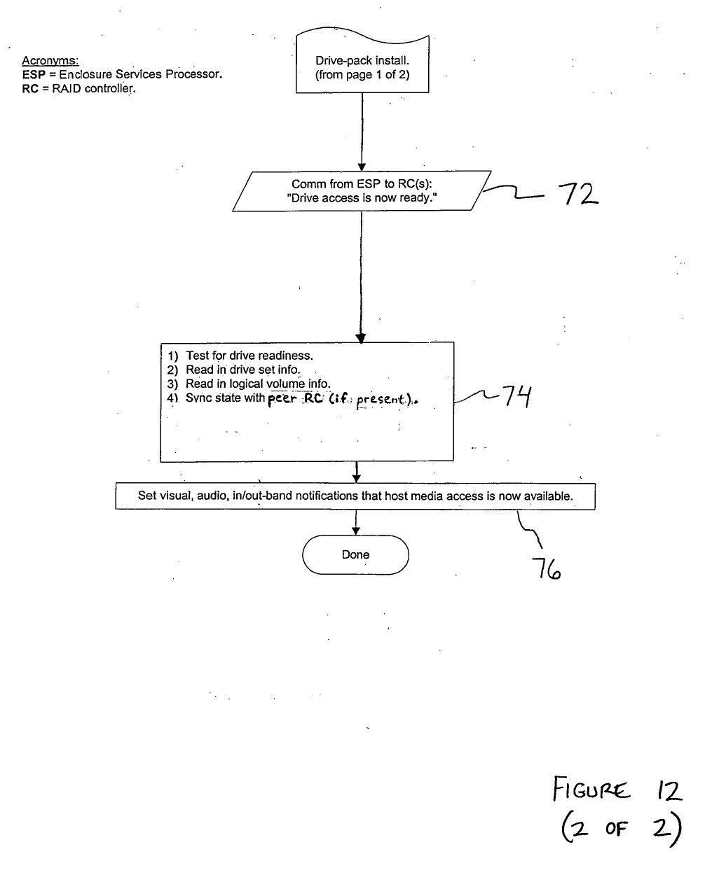

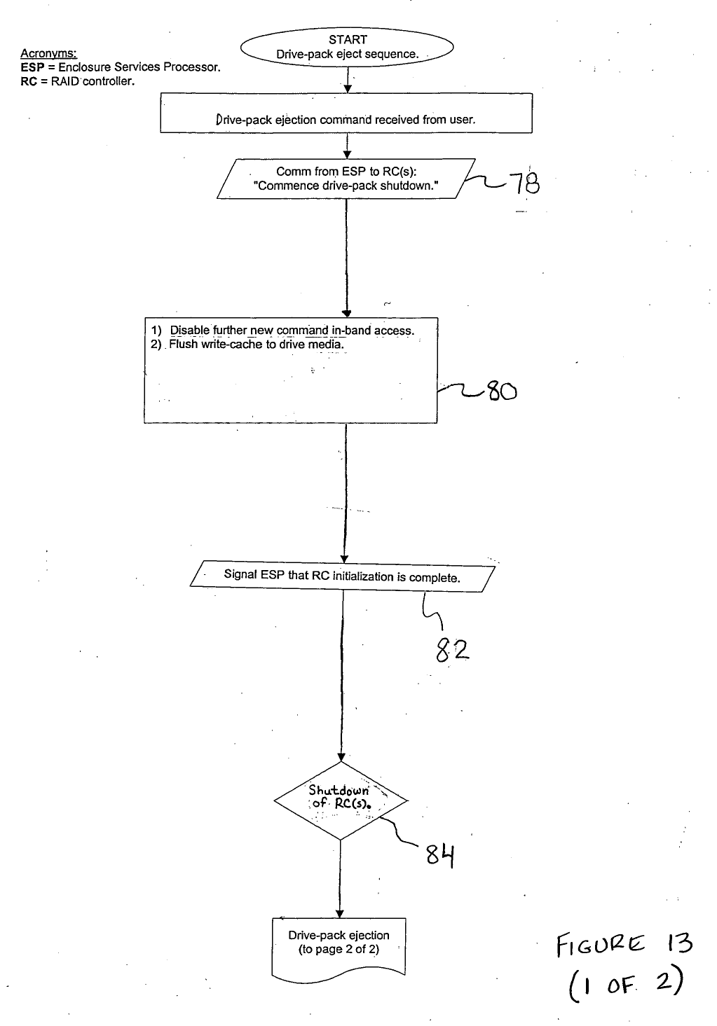

FIG. 12 is a block diagram illustrating a system process for installing the drive pack 14 in accordance with certain embodiments of the invention. When the drive pack 14 is inserted into the bay 34 of the principal enclosure of the computer drive pack assembly 10 and the electronic signal and power connector 30 of the drive pack 14 (shown in FIG. 4) engages the corresponding female connector 42 in the ESI Board 40 (shown in FIG. 9) as in step 56, a debounce delay in step 58 is allotted for proper seating and securing by the user. The ESI Board 40 subsequently begins the process of powering the drive pack 14 and bringing it online. This is preferably done over a series of events executed by a processor on the board 40 that first involves initialization in step 60, i.e., loading volatile programmable parts, control state setup, status checks and BIST (Built In Self Test) as in step 62) of the Drive Service Board 36 of the drive pack 14. The environmental condition of the drive pack 14 is checked in step 64 and a sequence is initiated in step 66 if the condition is not acceptable. In certain preferred embodiments, fan power would also be engaged, particularly when an environmental condition check indicates an elevated temperature. The drives 18 are powered up in a staggered progression in step 68 (the processor on the ESI board 40 has individual power control over each drive) to prevent fatal line/load power rail fluctuations. The drives 18 are enabled on the back-end internal data buses in step 70. Finally, interaction between the at least one RAID controller 44 and the individual drives 18 begins in step 72. The drives 18 are tested, and media resident configurations are read and processed in step 74. The RAID and LUN configurations are setup and communicated to the host system along with changes to the removable media status in step 74 as well. In step 76, the ESI processor then communicates through the light indicators to the user that the drive pack 14 is online and operational. Codes for any fault conditions detected during the installation procedure are also displayed. This information is also communicated in-band to the host system and out-of-band to the user by various protocols (e.g., SMTP, SNMP, HTTP, etc.).

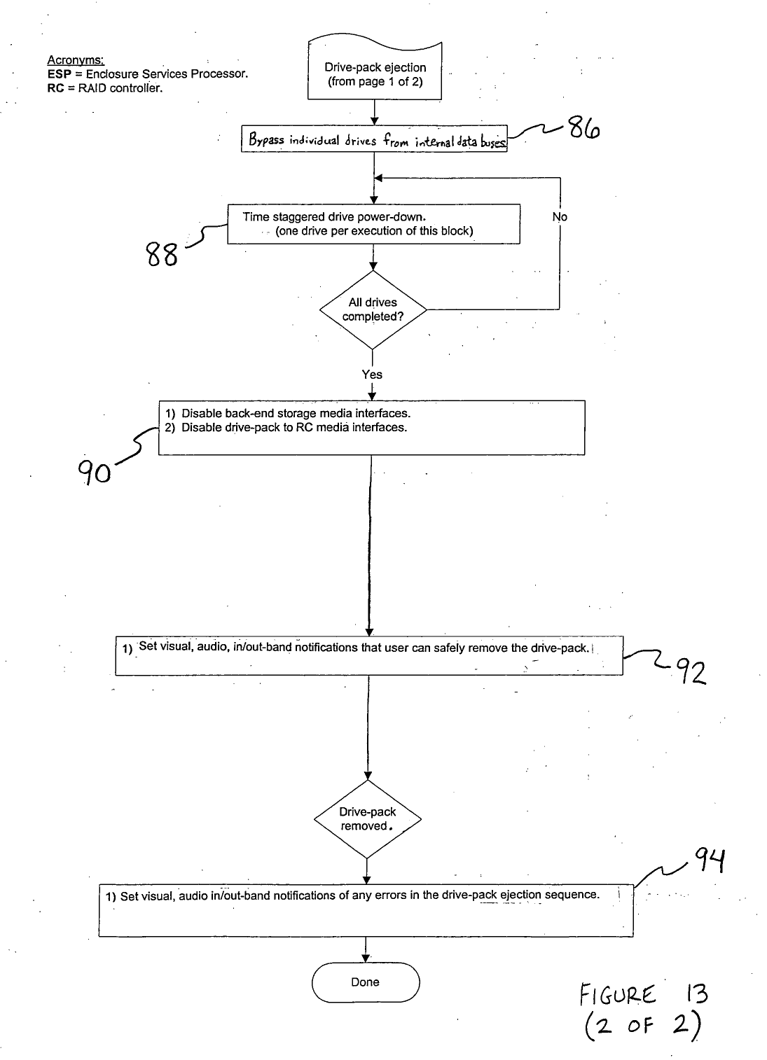

FIG. 13 is a block diagram illustrating a system process for removing the drive pack 14 in accordance with certain embodiments of the invention. When the drive pack 14 is removed from the principal enclosure 12 of the computer drive pack assembly 10, changes to the removable media status may be communicated to the host in step 78. Preferably, host data transfers are shut down in step 80. Further, cache is flushed to the drive pack media by each of the at least one RAID controller 44 in step 80. Configurations, drive pack statuses, logging information, etc., are written to the drive pack media and non-volatile memory by the at least one RAID controller 44 and the processor of the ESI Board 40. Once the at least one RAID controller 44 has indicated to the processor of the ESI board 40 that the shutdown procedures are complete in step 82, the processor begins its own shutdown procedure in step 84. The processor bypasses the individual drives 18 from the internal data buses in step 86, powers them down in a staggered progression in step 88, and sets up control and status signals for drive pack 14 disengagement in step 90. Once the drive pack 14 is ready for physical removal, the processor of the ESI board 40 communicates to the user through light indicators that it can now be extracted or exchanged in step 92, as well as communicating any fault conditions detected during the removal procedure in step 94. This information is also communicated in-band to the host system and out-of-band to the user by various protocols (e.g., SMTP, SNMP, HTTP, etc.).

In conjunction with the aforementioned aspects of the invention involving the removal, exchange, and transportation of the drive pack 14 from the principal enclosure 12 of the computer drive pack assembly 10, there are certain embodiments of the invention that involve the removal, exchange, and repair of the individual drives 18 while the drive pack 14 itself remains in the principal enclosure 12, live and online, i.e., during a period of full bandwidth access between drive pack media and host media. This ability, termed Live Drive Access (LDA), requires mechanical, electrical, and embedded software design considerations in the embodiment.

As shown in FIG. 2, the drive protection panel 16 can be opened when the drive pack 14 is installed in the principal enclosure 12. In turn, the drive protection panel 16 can be opened for individual drive 18 access while the drive pack media is online and performing active data transfers. In particular, once the panel 16 is opened, there is full access to the plurality of drives 18. At that point, the drives 18 can be individually removed or inserted along the guide rail trays 54 contained within the framework of the drive pack 14 (FIG. 11).

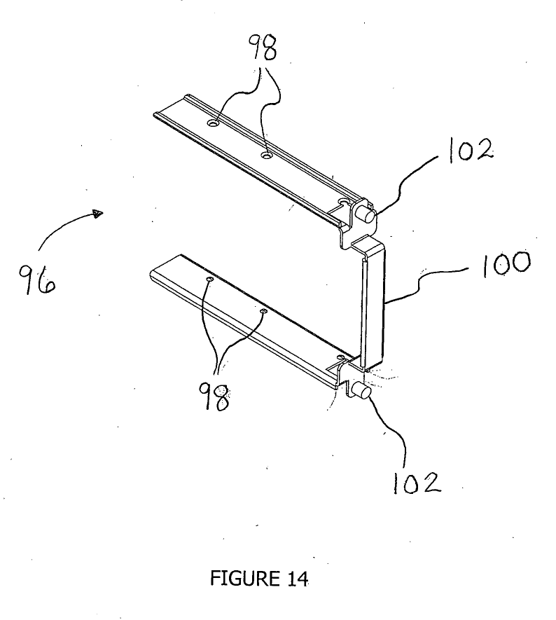

FIG. 14 illustrates a front perspective view of a drive shuttle 96 in accordance with certain embodiments of the invention. The drive shuttle 96 (shown without accompanying individual drive 18) consists primarily of a single-piece construction that is secured to a corresponding individual drive 18 via self-aligning fastening holes 98. The shuttle 96 includes a handle 100 along a front surface. The shuttle 96 has tool-less bay frame fasteners 102 that function in securing the shuttle 96 to upper and lower internal framework crossbars of the drive pack 14.

In order to facilitate LDA in the invention, redundant RAID data bindings are preferably created across the media of the individual drives 18 with the support of embedded software/hardware support in the system, i.e., the RAID controllers 44, the Drive Service Board 36, and the ESI Board 40. Without such support, a failure, removal, or replacement of one of the individual drives 18 would tend to cause an immediate failure of the computer drive pack assembly 10 as well. In addition, the embedded software/hardware support must also'be present to enable or bypass, as appropriate, the replacement drive on the redundant back-end data buses to ensure the buses remain operational despite the failure mode of the individual drive, drive engagement and disengagement from the buses, or an open connection along the buses.

Once an individual drive 18 is installed, it preferably is powered on and enabled on the redundant back-end data buses. This is taken care of by the processor on the ESI Board 40 and the control circuitry on both the ESI Board 40 and the Drive Service Board 36. The individual drive 18 then is brought online and tested. Finally, the drive 18 preferably needs to have redundant data rebuilt across its entire capacity based on parity calculations made on the remaining drives' data, which is facilitated by the RAID controllers 44 as is known in the art. As is also known in the art, all of these processes are preferably done transparently to normal host system activity and its access to the invention's media data.

Inserting and removing individual drives 18 can cause problems with DC load regulation. Drive spindle and armature actuation can also cause potent AC content noise fluctuations as well as DC load regulation issues. These power considerations are preferably addressed with capacitive bypass filtering, isolated power and ground planes feeding directly from the power supplies 48 to the drive pack 14, power supply load sharing, power supply sense line feedback both on the power rail (for load regulation) and on the ground rail (for common mode rejection), a plurality of multiple length pre-charge contacts on the drive pack electrical signal and power connector 30, and multi-layer copper pours around all power connections with a plurality of current-feed vias. In addition, all supply voltages to all drives 18 are FET switch driven and under ESI processor control. This allows for temporally staggered spin-up and spin-down algorithms as is known in the art, thus ameliorating AC noise and DC load aggregation.

While preferred embodiments of the present invention have been described, it should be understood that a variety of changes, adaptations, and modifications can be made therein without departing from the spirit of the invention and the scope of the appended claims.

1. A computer drive pack assembly comprising:
a) a principal enclosure;
b) a housing within the principal enclosure, the housing adapted for removal and transport from the principal enclosure, the housing containing a plurality of drives, each of the plurality of drives adapted for removal from the housing; and
c) at least one RAID controller within the principal enclosure and operatively connected to one or more of the plurality of drives, the at least one RAID controller configured to store data for the connected drives.

2. The assembly of claim 1, wherein the at least one RAID controller is operatively connected to each of the plurality of drives.

3. The assembly of claim 1, wherein the at least one RAID controller is operatively connected to data streams and data pathways of the drives.

4. The assembly of claim 1, wherein the at least one RAID controller is in communication with the drives when the housing is within the primary enclosure.

5. The assembly of claim 1, wherein the data comprises redundant data.

6. The assembly of claim 1, wherein the housing includes a drive circuit having electrical components and connectors operatively coupled to each of the plurality of drives, the circuit adapted to provide individual power and data control to each of the plurality of drives, whereby the circuit operatively connects the plurality of drives to the at least one RAID controller.

7. The assembly of claim 1, wherein the housing includes an electronic connector adapted to form an electronic interconnection between the drives within the drive pack and any engaging mechanism, whereby the electronic connector operatively connects the plurality of drives to the at least one RAID controller.

8. The assembly of claim 1, wherein the principal enclosure includes an enclosure circuit having a plurality of electrical connectors and one or more processors, the plurality of connectors adapted to engage and interconnect the drive pack and the at least one RAID controller, the one or more processors adapted to individually control the operation of the plurality of drives, whereby the enclosure circuit operatively connects the at least one RAID controller to the plurality of drives.

9. The assembly of claim 1, wherein the at least one RAID controller is configured to provide the data to the plurality of drives prior to a housing being removed.

10. The assembly of claim 1, wherein the at least one RAID controller is adapted for removal and transport from the principal enclosure.

11. A computer drive pack assembly comprising:
a) a principal enclosure;
b) a drive pack operatively coupled to the principal enclosure and adapted for removal and transport from the principal enclosure, the drive pack containing a plurality of drives, each of the plurality of drives adapted for removal from the housing;
c) one or more support modules, each of the one or more modules operatively coupled to the principal enclosure; and
d) an enclosure circuit operatively coupled to the principal enclosure, the enclosure circuit configured to interconnect the drive pack and the one or more support modules.

12. The assembly of claim 11, wherein the one or more support modules includes one or optionally more of at least one power supply, at least one RAID controller, at least one fan pack, at least one RAID controller, a rechargeable battery backup unit, and an user interface module.

13. The assembly of claim 11, wherein each of the one or more support modules comprises a unit separate from the principal enclosure, each of the one or more support modules adapted for removal from a bay in the principal enclosure.

14. The assembly of claim 11, wherein the securement of the drive pack, the one or more support modules, and the enclosure circuit to the principal enclosure enables the principal enclosure to be ruggedized.

15. The assembly of claim 11, wherein the drive pack includes a drive circuit having electrical components and connectors operatively coupled to each of the plurality of drives, the drive circuit adapted to provide individual power and data control to each of the plurality of drives, whereby the drive circuit is operatively connected to the one or more support modules to the drive pack.

16. The assembly of claim 11, wherein the drive pack includes an electronic connector positioned at a posterior side of the housing, whereby the connector is adapted to form a sole electronic interconnection between the drives within the drive pack and any engaging mechanism, whereby the electronic connector operatively connects the one or more support modules to the drive pack.

17. The assembly of claim 11, wherein the enclosure circuit includes a plurality of electrical connectors and one or more processors, the plurality of electrical connectors adapted to engage and interconnect the one or more support modules to the drive pack, and the one or more processors adapted to individually control the operation of the plurality of drives.

18. The assembly of claim 11, wherein the engagement of the enclosure circuit between the drive pack and the one or more modules provides a mechanism for data storage from the plurality of drives to the one or more support modules.

19. A method of creating a redundant data system in a computer drive pack assembly comprising:
a) providing a principal enclosure having one or more support modules and an enclosure circuit contained therein;
b) providing a drive pack adapted for removal and transport from the principal enclosure, the drive pack comprised of a housing containing a plurality of drives and a drive circuit, each of the plurality of drives adapted for removal from the housing; and
c) coupling operatively the drive pack to the principal enclosure.

20. The method of claim 19, further comprising coupling operatively each of the one or more support modules to the enclosure circuit in the principal enclosure and coupling operatively each of the plurality of drives to the drive circuit in the drive pack.

21. The method of claim 20, wherein the step of coupling the drive pack to the principal enclosure further comprises coupling operatively the drive circuit to the enclosure circuit so as to interconnect the plurality of drives of the drive pack to the one or more support modules of the principal enclosure.

22. The method of claim 19, wherein the step of providing the principal enclosure having one or more support modules comprises having one or optionally more of at least one power supply, at least one RAID controller, at least one fan pack, at least one RAID controller rechargeable battery backup unit, and an user interface module.

23. The method of claim 22, wherein the step of providing each of the at least one RAID controller further comprises operatively connecting data streams and data pathways of the drives to the at least one RAID controller in order to store redundant data of the plurality of drives.

24. The method of claim 19, further comprising a step of removing one or more of the plurality of drives from the drive pack while the computer drive pack assembly is energized, during in-band or out-of-band communication, or during storage media data access.

25. The method of claim 19, further comprising a step of removing the drive pack from the principal enclosure while the computer drive pack assembly is energized and during in-band or out-of-band communication.

26. The method of claim 19, further comprising a step of removing one or more of the plurality of support modules from the principal enclosure while the computer drive pack assembly is energized, during in-band or out-of-band communication, and during storage media data access.

27. A method of enabling a plurality of drives to function properly within a computer drive pack assembly following insertion of a drive pack containing the plurality of drives into the computer drive pack assembly, comprising:
a) powering the drive pack;
b) initializing a drive circuit of the drive pack to default control status with an electronic circuit within the computer drive pack assembly;
c) testing the drive pack;
d) enabling the plurality of drives on back-end storage media interfaces of the computer drive pack assembly;
e) powering the plurality of drives within the drive pack;
f) testing the plurality of drives for readiness;
g) reading data from the plurality of drives;
h) synchronizing the computer drive pack assembly with data from the plurality of drives; and
i) setting one or optionally more of visual, audio, and in/out of band notifications that proper functioning between the plurality of drives of the drive pack and the computer drive pack assembly is now available.

28. The method of claim 27, wherein the drive pack powering step further comprises using a debounce delay period during which proper securing of the drive pack can be made within the computer drive pack assembly.

29. The method of claim 27, wherein the drive pack testing comprises testing the functioning of the drive circuit.

29. The method of claim 27, wherein the drive powering step comprises powering the drives in a staggered sequence.

30. The method of claim 27, wherein the drive data reading step comprises reading media resident configurations.

31. The method of claim 27, further comprising the step of checking an environmental condition of the drive pack.

32. The method of claim 31, further comprising the step of initiating a sequence to remedy the environmental condition.

33. A computer readable medium comprising the instructions for performing the method of claim 27.

34. A method of enabling a plurality of drives to function properly within a second computer drive pack assembly following removal of a drive pack containing the plurality of drives from a first computer drive pack assembly, comprising:
a) disabling further data transfers between the drives and the first computer drive pack assembly;
b) flushing write-cache to the plurality of drives;
c) bypassing individual drives from internal data buses;
d) powering down a plurality of drives within the drive pack;
e) setting controls and statuses for drive pack disengagement;
f) setting one or optionally more of visual, audio, and in/out of band notifications that user can now safely remove the drive-pack; and
g) setting one or optionally more of visual, audio, and in/out of band notifications of any errors in the drive-pack ejection sequence.

35. The method of claim 34, wherein the write-cache flushing step further comprises writing one or optionally more of configuration information, drive pack statuses, and logging information to the plurality of drives.

36. The method of claim 34, wherein the drive powering step comprises powering the drives in a staggered sequence.

37. The method of claim 34, wherein the controls and statuses setting comprises disabling media interfaces between the drive pack and the computer drive pack assembly.

38. A computer readable medium comprising the instructions for performing the method of claim 34.
